(19) United States
(12) Patent Application Publication
(10) Pub. No.: US 2026/0003254 A1
(43) Pub. Date: Jan. 1, 2026

(54) Strap Locking Mechanism and Camera Quick Hanging Mechanism with the Locking Mechanism

(71) Applicant: PGYTECH CO.,LTD, Jiangsu (CN)

(72) Inventors: Bingchao XIA, Jiangsu (CN); Mingzhu HAN, Jiangsu (CN)

(73) Assignee: PGYTECH CO.,LTD, Jiangsu (CN)

(21) Appl. No.: 19/031,440

(22) Filed: Jan. 18, 2025

(30) Foreign Application Priority Data
Jun. 26, 2024 (CN) 202421483354.1

(51) Int. Cl. G03B 17/56

(52) U.S. Cl. CPC G03B 17/566; G03B 17/561

(57) ABSTRACT

The present disclosure provides a strap locking mechanism and a camera quick-hanging mechanism containing the same, comprising a base and a cover plate rotatably connected with the base, wherein a strap exists between the base and the cover plate; a primary locking mechanism is arranged between the base and the cover plate for locking or unlocking the base and the cover plate; the cover plate is provided with a secondary locking mechanism and a pressing plate rotatably connected to the cover plate in a direction towards the base; the pressing plate is used to control the secondary locking mechanism to lock or unlock the strap.

### CROSS-REFERENCE TO RELATED APPLICATIONS

This application claims the priority of China Patent Application No. 202421483354.1 filed on Jun. 26, 2024, entitled “Strap Locking Mechanism and Camera Quick Hanging Mechanism Containing the Locking Mechanism”, all the contents and amendments of which are incorporated into this application by reference.

### TECHNICAL FIELD

The present disclosure relates to the technical field of strap locking in camera assembly, particularly to a strap locking mechanism and a camera quick hanging mechanism containing the locking mechanism.

### BACKGROUND

Camera is a kind of equipment that uses the principle of optical imaging to form and record images. When it is widely used in daily life, in order to facilitate carrying and using, many accessories are derived for camera carrying and using, such as the installation plate and strap of a camera. The existing straps are usually locked in the following ways:

Locking the strap by clamping and locking the two sides and allowing the plate buckle to pass through the dead point of the lever; and locking the strap by screws.

The above-mentioned methods have a small adaptation range, and once parts and components need to be replaced, they need complicated operations. When they are used for quick hanging of cameras, the straps are not firmly clamped, and under certain circumstances, for example, when the force is large, they are easy to unlock, causing safety problems.

The existing U.S. Pat. No. 18,552,552 discloses an “A strap buckle and an operation method therefor”. This patent designs the hook body to be connected with the fastener, so as to connect the strap at any position. However, due to the spherical connection structure of its hook, it is easy to cause the hook to fall off once the force is too large. Therefore, this design without double fixing mechanism will increase the occurrence of camera falling off due to unstable fixing, which is likely to cause safety problems.

Therefore, there is a need to propose a locking mechanism which is suitable for stably fixing the camera on the strap and has a double fixing mechanism, so as to improve the carrying safety of the camera.

### SUMMARY

An object of the present disclosure is to provide the installation seat of the quick-installation plate and the camera quick-hanging, which act on a trigger part during assembly, and then drive a sliding part and a locking part to move in different directions, so that less space is occupied. In addition, this movement mode can complete the disassembly and installation of the quick-installation plate without adding other redundant structures in the assembly cavity, which makes it more adaptable to the quick-installation plate and expands its application range.

In order to achieve the above object, the present disclosure is realized by the following technical solution.

In order to achieve the above object, the present disclosure provides a strap locking mechanism, which includes a base, wherein the base is rotatably connected with a cover plate, and a strap exists between the base and the cover plate, wherein a primary locking mechanism is arranged between that base and the cover plate for locking or unlocking the base and the cover plate; and the cover plate is provided with a secondary locking mechanism and a pressing plate rotatably connected to the cover plate in a direction towards the base; and the pressing plate can be forced to rotate to be close to or far away from the secondary locking mechanism, so as to control the secondary locking mechanism to form a locking force or a release locking force for controlling the locking or unlocking of the strap.

The present disclosure further provides a camera quick hanging mechanism, which includes a base, wherein the base is rotatably connected with a cover plate; a strap exists between the base and the cover plate; a primary locking mechanism is arranged between the base and the cover plate; the primary locking mechanism is used for locking or unlocking the base and the cover plate; the cover plate is provided with a secondary locking mechanism and a pressing plate rotatably connected to the cover plate in the direction toward the base; and the pressing plate is forced to rotate to be close to or far away from the secondary locking mechanism, so as to control the secondary locking mechanism to form a locking force or a release locking force for controlling the locking or unlocking of the strap;

the camera quick hanging mechanism further includes an installation seat formed by the base and a quick-installation plate located on the installation seat, and the quick-installation plate is provided with a camera with the strap.

### BRIEF DESCRIPTION OF DRAWINGS

The drawings, which constitute a part of this application, are used to provide a further understanding of the present disclosure. The illustrative embodiments of the present disclosure and the description thereof are used to explain the present disclosure, and do not constitute undue limitations on the present disclosure. In the drawings:

FIG. 1 is a schematic structural diagram of a strap locking mechanism provided by the present disclosure;

FIG. 2 is a sectional view of the strap locking mechanism provided by the present disclosure;

FIG. 3 is a use state diagram of the pressing plate in the strap locking mechanism provided by the present disclosure when unlocked;

FIG. 4 is a sectional view of the strap locking mechanism provided by the present disclosure when the pressing plate is unlocked;

FIG. 5 is a use state diagram of the pressing plate in the strap locking mechanism provided by the present disclosure when locking;

FIG. 6 is a sectional view of the strap locking mechanism provided by the present disclosure when the pressing plate is locked;

FIG. 7 is a structural schematic diagram of another embodiment of the strap locking mechanism provided by the present disclosure;

FIG. 8 is a schematic sectional view of FIG. 7;

FIG. 9 is a schematic structural view of the embodiment of the strap locking mechanism in FIG. 7 in an open state;

The above drawings include the following reference signs:

100, Base; 200, Strap; 300, Cover plate; 310, Rotating shaft; 320, Extension part; 400, Primary locking mechanism; 500, Secondary locking mechanism; 510, Pressing plate; 511, Extrusion part; 520, Hook; 530, Clamping groove; 540, Driving mechanism; 550, Unlocking button; 560, Spring tongue; 570, Knob connector.

### DESCRIPTION OF EMBODIMENTS

The technical solution in the embodiment of the present disclosure will be clearly and completely described below with reference to the drawings. Obviously, the described embodiment is part of, rather than all of the embodiments of the present disclosure. The following description of at least one exemplary embodiment is illustrative in nature and is in no way intended to limit the present disclosure, its application or uses. Based on the embodiments in the present disclosure, all other embodiments obtained by those skilled in the art without creative work belong to the scope of protection of the present disclosure.

It should be noted that the terminology used here is only for describing specific embodiments, and is not intended to limit exemplary embodiments according to the present application. As used herein, the singular form is also intended to include the plural form unless the context clearly indicates otherwise. Furthermore, it should be appreciated that when the terms “comprising” and/or “including” are used in this specification, they specify the presence of features, steps, operations, devices, components and/or combinations thereof.

Unless otherwise specified, the relative arrangement of components and steps, numerical expressions and numerical values set forth in these embodiments do not limit the scope of the present disclosure. At the same time, it should be appreciated that for the convenience of description, the dimensions of various parts shown in the drawings are not drawn according to the actual scale relationship. Techniques, methods and equipment known to those skilled in the art may not be discussed in detail, but in appropriate cases, they should be regarded as part of the authorization specification. In all the examples shown and discussed herein, any specific values should be interpreted as illustrative, and not as limiting. Therefore, other examples of exemplary embodiments may have different values. It should be noted that similar numbers and letters indicate similar items in the following drawings, therefore once an item is defined in one drawing, it does not need to be further discussed in subsequent drawings.

### Embodiment 1

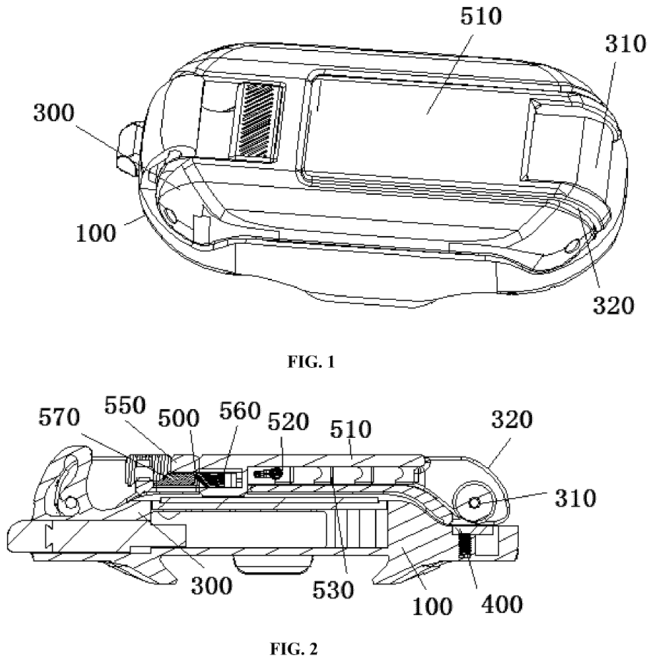

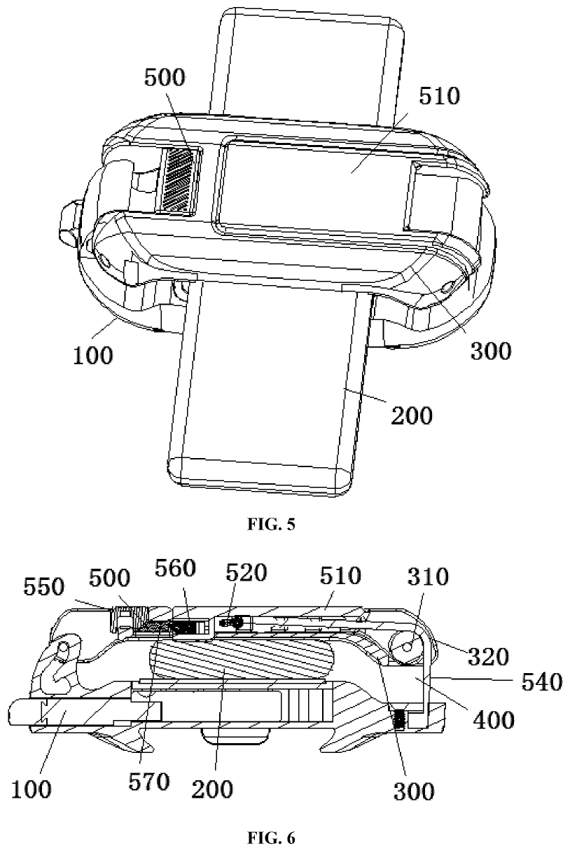

Referring to FIGS. 1-6, the strap locking mechanism in this embodiment first includes a base 100, on which an assembly surface is formed to facilitate the placement of a strap 200. The strap locking mechanism further includes a cover plate 300 rotatably connected with the base 100, and the strap 200 is located between the base 100 and the cover plate 300. At this time, a primary locking mechanism 400 is added between the base 100 and the cover plate 300, so that when the cover plate 300 is close to the base 100, the cover plate 300 and the base 100 are primarily locked, thereby completing the primary locking of the strap 200. The locking in this case may be in various locking modes such as clamping.

In order to make the locking firm, in this embodiment, the cover plate 300 is additionally provided with secondary locking. At this time, a secondary locking mechanism 500, which is set near the base 100, is also rotatably connected to the cover plate 300. In particular, a pressing plate 510 rotates along the cover plate 300 and then approaches or moves away from the cover plate 300. In this process, the pressing plate 510 controls the secondary locking mechanism 500 to form a locking force, thereby completing the secondary locking of the strap 200, or moves away to release the locking force to complete the unlocking.

When this embodiment is used, the secondary locking of the strap is completed by skillfully using the way of rotating and matching the pressing plate. In the following, the secondary locking mechanism and the primary locking mechanism are introduced respectively.

Firstly, the secondary locking mechanism is introduced.

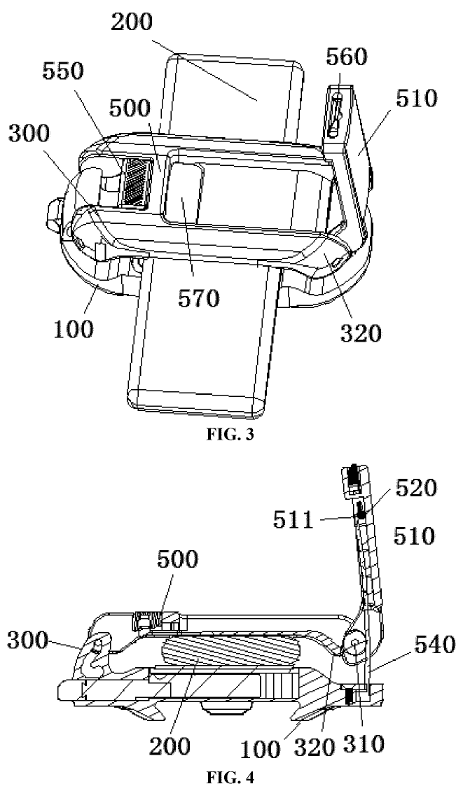

Referring to FIGS. 3 and 4, it can be seen that in this embodiment, the pressing plate 510 in the secondary locking mechanism 500 forms a pressing part 511 facing the strap 200, and a pressing surface is formed on the pressing part 511. At this time, the pressing surface is in contact with the strap 200 to complete the pressing. At this time, the protrusion forms a local pressing surface, so that the strap 200 is pressed at a set position, which makes it possible to adjust the position of the pressing surface subsequently and apply it to straps with different widths.

Specifically, for the convenience of assembly, the secondary locking mechanism is a hook 520 protruding toward the base and hung at the set position of the pressing plate 510. At this time, the hook 520 forms an extrusion surface acting on the strap, and when the pressing plate rotates, it drives the hook 520 to rotate, so as to realize the locking and unlocking process, thus achieving multiple goals.

In order to expand its application range and make it suitable for straps with various widths, in this embodiment, a plurality of clamping grooves 530 matched with the hook 520 are provided on the pressing plate 510 along the width direction of the strap 200. At this time, by matching with different clamping grooves 530, extrusion clamping cavities with different widths are formed to match straps with different widths.

In this embodiment, in order to realize the rotation of the pressing plate 510, a driving mechanism 540 for driving the secondary locking mechanism 500 to rotate is further linked to the pressing part 511. Compared with the mode of directly driving the pressing plate, in this embodiment, the pressing plate is driven to rotate by the pressing part 511 or the hook 520. On the one hand, the driving mechanism can be hidden inside to ensure safe use and beautiful appearance; on the other hand, such a driving mode is driven from the inside, which has little influence on the outside of the pressing plate 510.

Specifically, a rotating shaft 310 is provided at the end of the cover plate 300, and an avoidance groove is formed at a position of the pressing plate 510 close to the rotating shaft 310. With this avoidance groove, the driving mechanism 540 can extend out of the whole cover plate and avoid the rotation of the two to avoid influence.

Specifically, the driving mechanism 540 is a flexible belt arranged along the pressing plate 510 and fixed on the base 100 through an avoidance groove. At this time, it may also be a knitted belt. In this embodiment, the other end of the driving mechanism 540 is fixed on the base 100, and it can be fixedly connected with the pressing plate during rotation, so that its length will not change. However, because part of the driving mechanism is exposed at the avoidance groove, it is convenient for users to drive the pressing plate 510 to rotate by operating the exposed flexible connecting belt.

Further, the secondary locking mechanism further includes an unlocking button 550 and a knob connector 570, which are arranged far away from the avoidance groove and located on the cavity of the cover plate 300. A spring tongue 560 is arranged on the pressing plate 510, or the spring tongue 560 is fixedly connected with the hook 520, and then the unlocking button 550 is operated to unlock the pressing plate 510 locked on the cover plate 300. The pressing plate 510 can be rotated by the driving mechanism 540 at this time, and when rotated reversely to be close to the base 100, the pressing plate 510 applies a downward force, and the spring tongue 560 enters the cavity to realize locking. When the pressing plate 510 is opened, the strap 200 is placed between the cover plate 300 and the base 100, the driving mechanism 540 formed by the hook is hung on the pressing plate 510, the pressing plate 510 rotates along the cover plate 300, and the driving mechanism 540 formed by the webbing is locked. Finally, the pressing plate 510 is covered in the cover plate 300, and the spring tongue 560 bounces into the cavity of the cover plate 200 from the cavity of the pressing plate 510. The pressing plate 510 is locked so as not to leave the cover plate 300, and the secondary locking is completed.

Secondly, with regard to the primary locking mechanism 400:

In this embodiment, the primary locking mechanism 400 is arranged near the avoidance groove. At this time, one of the cover plate 300 and the base 100 can be provided with a buckle and the other with a slot, and then the buckle and the slot can be matched during rotation to complete the assembly. At this time, the primary locking mechanism may be any one known in the prior art.

In this embodiment, the cover plate 300 forms a cavity structure through which the strap 200 passes, and the pressing plate 510 fills the cavity during rotation. Specifically, it can be seen that a part of the cover plate 300 is hollowed out, and then the pressing plate 510 just fills the hollowed out part, so that it forms a complete structure, which is not only beautiful in structure, but also saves raw materials.

In this embodiment, in order to achieve better assembly, the base 100 is recessed to form an assembly cavity with the primary locking mechanism 400. The cover plate 300 extends downward to form an extension part 320 matched with the assembly cavity, and the pressing plate 510 rotates at the extension part 320. In this embodiment, the extension part 320 has an arc structure, and then the rotating shaft 310 is arranged at the arc structure, so that the friction force borne in the rotation is reduced and the rotation is more convenient.

Thirdly, with regard to the whole rotating process:

In this embodiment, it can be seen that, specifically, the secondary locking is completed through the secondary rotation, and the rotating shaft of the secondary rotation can be located at two sides of the base 100, so that the whole stress and the like can be dispersed in time, and abrasion and the like can be prevented from occurring only on one side. At the same time, the secondary locking in this embodiment is somewhat similar to the principle of cam, but it is not only simple clamping, but also uses the spring tongue and the like to lock the pressing plate while pressing it. Specifically, the unlocking button 550 and the like are used in cooperation to further lock the pressing part 511 after it is pressed against the strap 200.

### Embodiment 2

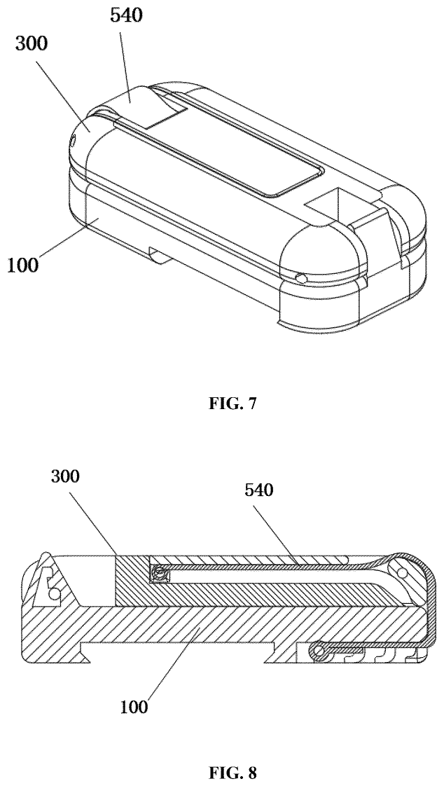

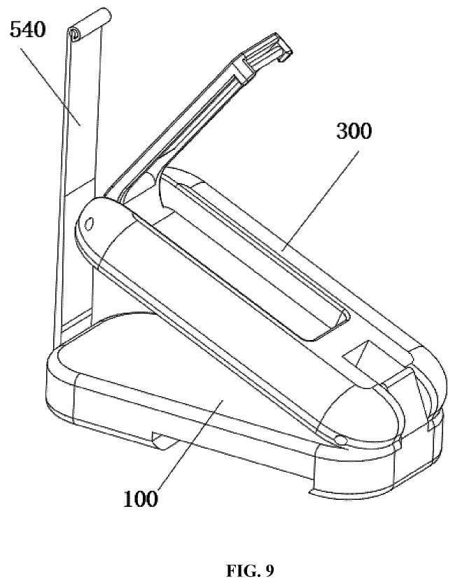

Referring to FIG. 7-9, the strap locking mechanism in this embodiment includes a base, which is rotatably connected with a cover plate, and a strap exists between the base and the cover plate, wherein
a primary locking mechanism is arranged between that base and the cover plate for locking or unlocking the base and the cover plate; and
the cover plate is provided with a secondary locking mechanism and a pressing plate rotatably connected to the cover plate towards the base; and
the pressing plate is forced to rotate to be close to or far away from the secondary locking mechanism, so as to control the secondary locking mechanism to form locking force or release locking force for controlling the locking or unlocking of the strap.

The secondary locking mechanism includes a driving mechanism, the bottom of the base is provided with a plurality of clamping grooves. One end of the driving mechanism is connected with the clamping grooves by a connecting post, and the other end of the driving mechanism passes through a middle part of the pressing plate and is connected with the cover plate by a fixing post.

When in use, a proper clamping groove is selected according to the width of the strap. One end of the locking mechanism is clamped with the base by the connecting post, and the other end is connected with the cover plate by the fixing post. During usage, the strap can be locked by simply turning over the pressing plate and tightening the driving mechanism.

The working principle in this embodiment is as follows:

The cover plate 300 is hinged to one side (for example, the left side) of the base 100. The cover plate 300 is rotated to be close to the base 100, and then the strap 200 on the base 100 is pressed to achieve primary fixation. Then, the pressing plate 510 hinged to the cover plate 300 can rotate on the left side or the right side, but it is preferably on the right side of the bottom plate, so that both sides rotate and the force is dispersed. As for locking, after the primary locking is completed, a ribbon rope (that is, the driving mechanism 540) on the hook 520 on the inner wall of the pressing plate 510 is used to start the relevant operation. At this time, it can be seen that the driving mechanism penetrates the pressing plate 510 from the right side of the pressing plate, and then is controlled to rotate. During the rotation, the pressing plate 510 is locked at the base 100 and the cover plate body, and the cover plate 300 is driven to press down to generate a pressing force against the strap 200, thereby realizing the clamping and locking of the strap 200.

This embodiment is used in the quick-hanging structure of the camera for assembling the camera. Then, an installation seat of the quick-hanging structure is formed by using the base 100, a quick-installation plate for assembling the camera and the like is arranged on the installation seat, and then a strap on the camera can be locked by the structure in this embodiment. The quick-installation plate located on the installation seat is provided with a camera with the strap.

From the above description, it can be seen that the above embodiments of the present disclosure have achieved the following technical effects: firstly, in the present disclosure, primary locking is realized between the cover plate and the base, and then a secondary locking mechanism is added, therefore the strap is actually locked twice, which is more firm than other locking methods.

Secondly, in the present disclosure, the fitting between the cover plate and the base is completed by rotating, and then the fitting between the pressing plate on the cover plate and the base is formed by rotating again. Compared with locking modes such as buckles, the rotation produces extrusion, which is more ingenious in design and safer to use.

Thirdly, in the present disclosure, the hook with the protrusion can be fixed at different positions of the pressing plate to form locking at different positions, so that locking for pressed objects with different widths is realized, which is applicable in a wider range and suitable for popularization and use.

In the description of the present disclosure, it should be appreciated that the orientation or positional relationship indicated by orientation words such as “front, back, upper, lower, left, right”, “lateral, vertical, horizontal” and “top, bottom” are usually based on the orientation or positional relationship shown in the attached drawings, just for the convenience of describing the present disclosure and simplifying the description. Unless otherwise stated, these orientation words do not indicate or imply that the device or element referred to must have a specific orientation or be constructed and operated in a specific orientation, therefore they cannot be construed as limiting the scope of protection of the present disclosure. The orientation words “inside and outside” refer to the inside and outside relative to the outline of each component itself.

For the convenience of description, spatially relative terms such as “above”, “on”, “on the upper surface of” and “upper” can be used here to describe the spatial positional relationship between a device or feature as shown in the drawings and other devices or features. It should be appreciated that spatially relative terms are intended to encompass different orientations in use or operation in addition to the orientation of the device depicted in the drawings. For example, if the devices in the drawings are inverted, devices described as “above” or “on” other devices or structures will be positioned as “below” or “under” other devices or structures. Thus, the exemplary term “above” can include both orientation of “above” and “below”. The device can also be positioned in other different ways (rotated by 90 degrees or in other orientations), and the spatial relative description used here is explained accordingly.

In addition, it should be noted that the words “first” and “second” are used to define parts for the convenience of distinguishing the corresponding parts. Unless otherwise stated, the above words have no special meaning, and thus they cannot be construed as limiting the protection scope of the present disclosure.

What has been described above is only the preferred embodiment of the present disclosure, and it is not intended to limit the present disclosure. For those skilled in the art, the present disclosure may have various modifications and changes. Any modification, equivalent substitution, improvement and the like made within the spirit and principle of the present disclosure shall fall into the protection scope of the present disclosure.

What is claimed is:

1. A strap locking mechanism, comprising a base, wherein the base is rotatably connected with a cover plate, and a strap exists between the base and the cover plate, wherein
a primary locking mechanism is arranged between that base and the cover plate for locking or unlocking the base and the cover plate; and
the cover plate is provided with a secondary locking mechanism and a pressing plate rotatably connected to the cover plate in a direction towards the base; and
the pressing plate can be forced to rotate to be close to or far away from the secondary locking mechanism, so as to control the secondary locking mechanism to form a locking force or a release locking force for controlling the locking or unlocking of the strap.

2. The strap locking mechanism according to claim 1, wherein the secondary locking mechanism forms an extrusion part facing the strap, and an extrusion surface is formed on the extrusion part.

3. The strap locking mechanism according to claim 2, wherein the secondary locking mechanism comprises a hook protruding toward the base and hung at a set position of the pressing plate.

4. The strap locking mechanism according to claim 3, wherein a plurality of clamping grooves matched with the hook are formed on the pressing plate along a width direction of the strap.

5. The strap locking mechanism according to claim 2, wherein a driving mechanism for driving the secondary locking mechanism to rotate is linked with the pressing part.

6. The strap locking mechanism according to claim 5, wherein an end of the cover plate is provided with a rotating shaft, and an avoidance groove is formed close to the rotating shaft of the pressing plate.

7. The strap locking mechanism according to claim 6, wherein the driving mechanism is a flexible belt arranged along the pressing plate and fixed on the base by the avoidance groove.

8. The strap locking mechanism according to claim 6, wherein an end of the driving mechanism is provided with a collar that is fixedly connected with the hook.

9. The strap locking mechanism according to claim 6, wherein the base is provided with a fixing groove, on which a fixing piece is provided, and an end of the driving mechanism is fixedly connected with the base by the fixing piece.

10. The strap locking mechanism according to claim 9, wherein the fixing groove is connected to the fixing piece by a countersunk bolt.

11. The strap locking mechanism according to claim 1, wherein the cover plate forms a cavity structure through which the strap passes, and the pressing plate fills the cavity during rotation.

12. The strap locking mechanism according to claim 1, wherein the base is recessed to form an assembly cavity with the primary locking mechanism, the cover plate extends downward to form an extension part matched with the assembly cavity, and the pressing plate rotates at the extension part.

13. The strap locking mechanism according to claim 1, wherein the secondary locking mechanism comprises a driving mechanism, a bottom of the base is provided with a plurality of clamping grooves, an end of the driving mechanism is connected with the clamping grooves through a connecting post, and the other end of the driving mechanism passes through a middle part of the pressing plate and is connected with the cover plate by a fixing post.

14. A strap locking mechanism, comprising a base, wherein
the base is provided with a primary locking mechanism, which comprises a cover plate movably connected with the base; and a strap exists between the base and the cover plate, and the primary locking mechanism is matched with the base to realize locking or unlocking of the strap; and
the cover plate is provided with a secondary locking mechanism, which matched with the primary locking mechanism to further control the cover plate to be close to or far from the base.

15. The strap locking mechanism according to claim 14, wherein the primary locking mechanism further comprises a connecting belt, one end of which is connected with the base, and the other end of which is connected with the secondary locking mechanism; and the secondary locking mechanism is capable of controlling the cover plate to be close to or away from the base by tightening or loosening the connecting belt.

16. The strap locking mechanism according to claim 14, wherein the primary locking mechanism further comprises a rotating seat fixedly connected with the base, an L-shaped groove is formed in the rotating seat, and the cover plate is movably connected to the base by the L-shaped groove.

17. The strap locking mechanism according to claim 16, wherein the secondary locking mechanism forms an extrusion part facing the strap, and an extrusion surface is formed on the extrusion part;
the secondary locking mechanism comprises a hook protruding towards the base and hung at a set position of the pressing plate; and
an end of the driving mechanism is provided with a collar that is fixedly connected with the hook.

18. The strap locking mechanism according to claim 14, wherein the base is provided with a fixing groove, on which a fixing piece is provided; an end of the driving mechanism is fixedly connected with the base by the fixing piece, and the fixing groove is connected to the fixing piece by a countersunk bolt.

19. The strap locking mechanism according to claim 14, wherein an anti-slip sheet is arranged on the base at a contact position with the strap.

20. A camera quick-installation assembly, comprising the strap locking mechanism according to claim 1; and a quick-installation plate located on the base, wherein the quick-installation plate is provided with a camera with a backpack belt.
